(19) United States
(12) Patent Application Publication
(10) Pub. No.: US 2014/0246887 A1
(43) Pub. Date: Sep. 4, 2014

(54) PRESSURE-RESPONSIVE B-SURFACE SEAT OCCUPANCY SENSOR UNIT

(71) Applicants: Harald Clos, Saarbrucken (DE); Laurent Federspiel, Canach (LU); Peter Jonas, Konz (DE); Guenter Goedert, Trier (DE); Philippe Boyer, Boust (FR); Roberto Orsello, Luxembourg (LU); Christian Bour, Domprix (FR)

(72) Inventors: Harald Clos, Saarbrucken (DE); Laurent Federspiel, Canach (LU); Peter Jonas, Konz (DE); Guenter Goedert, Trier (DE); Philippe Boyer, Boust (FR); Roberto Orsello, Luxembourg (LU); Christian Bour, Domprix (FR)

(73) Assignee: IEE INTERNATIONAL ELECTRONICS & ENGINEERING S.A., Echternach (LU)

(21) Appl. No.: 14/240,850

(22) PCT Filed: Aug. 17, 2012
(86) PCT No.: PCT/EP2012/066063

§ 371 Date: May 21, 2014

(30) Foreign Application Priority Data
Aug. 31, 2011 (LU) 91 861

(51) Int. Cl. B60N 2/00; G01L 1/04

(52) U.S. Cl. CPC B60N 2/002; G01L 1/04
USPC 297/217.3; 73/862.621; 297/217.1

(57) ABSTRACT

A pressure-responsive B-surface seat occupancy sensor unit for detecting an occupancy state of a seat comprises a pressure sensor arranged on a base plate. The pressure sensor includes a printed circuit board having a first surface with at least two electrodes and a second surface, with which the PCB is arranged on the base plate, and a membrane element arranged in facing relationship with and spaced from the electrodes so as to deflect under pressure and establish an electrical contact between the electrodes. The base plate includes one or more fixation elements, by means of which the base plate is fixable to the structural frame, the seat cushion and/or the cushion-supporting springs of the seat.

### TECHNICAL FIELD

The present invention generally relates to sensing the occupancy state of an occupiable item, such as, in particular, a vehicle seat. Specifically, the invention relates to a pressure-responsive seat occupancy sensor that may be arranged at the B-surface of a vehicle seat, i.e. between the seat cushion and the supporting structure thereof (seat pan or springs).

### BACKGROUND ART

Seat occupancy sensors are nowadays widely used in automotive vehicles to provide a seat occupancy signal for various appliances, such as, e.g. a seat belt reminder, an auxiliary restraint system (airbag), etc. Seat occupancy sensors exist in a number of variants, e.g. based on capacitive sensing, deformation sensing or pressure (force sensing). Pressure-sensitive seat occupancy sensors have typically been arranged between the foam body of the seat cushion and the seat cover.

The possibility of customization and personalization of the vehicle by the customer is a key selling factor of modern cars. This leads to many different variants of car interiors being offered for one car model. With the increasing number of available options severe constraints arise concerning the implementation of technical equipment in the vehicle. With seat occupancy sensors arranged between the foam body of the seat cushion and the seat cover, every seat design (leather, cloth, sport, comfort, . . . ) requires specific development effort for the occupant detection system. That induces high development costs and therefore is an unattractive solution for the automotive industry. A problem to be solved is, therefore, to find a sensor solution, which is less influenced by seat design and thus can be used for a greater variety of of car seats or even car platforms.

Document DE 197 52 976 A1 discloses a vehicle seat occupancy sensor in the shape of a film-type pressure sensor. The pressure sensor includes a first carrier film, a spacer and a second carrier film, which are disposed on one another in the manner of a sandwich. Contact elements are arranged on the inner surfaces of the carrier films. An opening in the spacer allows the contact elements to get into contact with each other when pressure is applied on the sensor. The pressure sensor is arranged inside a cavity on the bottom side of the foam cushion of the vehicle seat. The pressure sensor is supported by a foam block, which closes the cavity and which rests on the seat pan.

Document DE 20 2010 003 563 U1 discloses a pressure-sensor unit, comprising a pressure sensor configured as a film-type sensor. The pressure sensor includes two films maintained at a distance by a spacer material arranged there between. The pressure sensor is disposed on a compressible intermediate layer, which is, in turn arranged on the base plate.

However, the pressure-sensor units of DE 197 52 976 A1 and DE 20 2010 003 563 U1 have the disadvantage that film-type pressure sensors typically become more sensitive at high temperatures (up to +85° C.) and less sensitive when submitted to low temperatures (down to −40° C.). As temperature should preferably have no influence on sensor activation, the design of film-type pressure sensors suitable for being used in a sensor arranged on the B-surface is complicated.

### TECHNICAL PROBLEM

It is an object of the present invention to provide an improved pressure-responsive B-surface seat occupancy sensor unit. This object is achieved by the invention as claimed in claim 1.

### GENERAL DESCRIPTION OF THE INVENTION

According to the invention, a pressure-responsive B-surface seat occupancy sensor unit for detecting an occupancy state of a seat, in particular a vehicle seat, comprises a pressure sensor arranged on a base plate. The pressure sensor includes a printed circuit board (PCB) having a first surface with at least two electrodes and a second surface, with which the PCB is arranged on the base plate, and a membrane element arranged in facing relationship with and spaced from the at least two electrodes so as to be able to deflect under pressure and establish an electrical contact between the at least two electrodes. The base plate includes one or more fixation elements, by means of which the base plate is fixable to the structural frame, the seat cushion and/or one or more of the cushion-supporting springs of the seat.

The seat occupancy sensor unit is thus configured for being integrated on the B-surface of a seat cushion foam. As will be appreciated, this environment is little or not influenced by the design of the seat parts that can be readily perceived by the user (such as e.g. the A-surface, on which the occupant may seat). For a particular car model, the B-surface is normally defined only once, namely at the moment of the seat frame design. The frame being a part of a car's passive safety concept, it will not be changed after the passive safety concept of a vehicle has been defined. As this happens at an early stage in the development of a car model, the supplier of the seat occupancy sensor unit gains more time for making adjustments, if necessary.

Advantageously, the pressure sensor is configured for reliably measuring low pressures e.g. in the range up to 100 mbar, preferably in the range up to 20 mbar. The seat foam distributes the forces induced by the occupant on the cushion-supporting seat pan or springs more or less uniformly to assure his seating comfort, resulting in low pressures at the sensor location on the B-surface. As will further be appreciated, thanks to its construction, the pressure sensor may be made relatively insensitive to environmental changes (e.g. temperature and humidity variations), so that it can reliably measure the low pressures involved. It is estimated that the total variation of the activation pressure over the full automotive temperature range (−40° C. to +85° C.) can be made as small as about 20% of the activation pressure at room temperature (20° C.), which is significantly less then can currently be achieved using film-type pressure sensors. The seat occupancy sensor unit is preferably configured such that a 5^{th}-percentile female seated on the seat results in the seat being detected as occupied, whereas a seat having lighter objects arranged on it is detected as empty.

The seat occupancy sensor unit is preferably configured small enough so as to have no negative impact on the occupant's seating comfort and not to influence (shift) the H-point of the car.

The pressure sensor preferably comprises one or more spacer elements arranged between the printed circuit board and the membrane that attach the printed circuit board and the membrane to one another. The one or more spacer elements preferably comprise an electrically insulating film that has the required thickness. The electrically insulating film could be a double-sided adhesive. The membrane, the spacer element(s) and the PCB could also be attached to one another by mechanical means, such as e.g. clips, clamps, rivets, screws, or the like.

Alternatively to the spacer element(s) attaching the membrane to the PCB, the base plate could comprise an elevated border disposed around the PCB, which the membrane could be fixed to.

The one or more spacer elements are preferably substantially incompressible (i.e. do not significantly yield under typical pressures induced by an occupant). Nevertheless, a variant of the invention could use compressible spacer elements; in this case, the activation of the pressure sensor will be due to a combination of the bending of the membrane and the yielding of the compressible spacer elements.

According to a preferred embodiment of the seat occupancy sensor unit, the membrane comprises (includes as a part or consists of) a metal foil. The thickness and the design of the metal foil are chosen so as to achieve the desired activation pressure. The membrane may also comprise a plastic film (e.g. made of PET, PEN, PI, PEEK, or the like) carrying an electrically conductive layer on its side facing the electrodes on the PCB. Such conductive layer could be a printed conductive surface or a metal foil attached to the plastic film.

When the membrane gets into contact with the at least two electrodes of the PCB, a current path is established between the electrodes via the membrane and the resistance between the electrodes drops from a high value (open circuit resistance value or integrity check resistance value) to a low value (e.g. ≦100 Ω). The resistance drop may be detected (as a change in resistance, current or voltage) by a control and evaluation circuit (e.g. an ASIC) attached to the seat occupancy sensor unit. Preferably, the at least two electrodes are arranged mutually interdigitated.

According to a preferred embodiment of the seat occupancy sensor unit, the PCB comprises, on the second surface, electrical connection elements electrically contacted with one or more of the at least two electrodes by throughplatings (vertical interconnect accesses: VIAs).

Preferably, the at least two electrodes are interconnected by at least one integrity check component (e.g. a resistor or a diode) arranged on the second surface of the PCB. The interconnection of the electrodes with such an integrity check component has the advantage that a circuit interruption can be detected.

The base plate preferably comprises one or more clearances (recesses or openings) for accommodating electrical components (e.g. an integrity check component or soldering pads by means of which a connection cable is connected to the electrodes) on the second surface of the printed circuit board.

The base plate also preferably comprise s positioning elements holding the printed circuit board in its correct position.

A cable guide may be provided on the base plate for guiding a connection cable to the printed circuit board, and, optionally, cramping the connection cable, so that any tension on the cable may be taken up by the base plate and is not directly transmitted to the soldering pads.

The seat occupancy sensor unit is preferably configured in such a way that it can be attached to the B-surface of the seat without any additional mounting equipment. Therefore a clip-type attachment is preferable. Preferably, at least one of the one or more fixation elements comprises an eyelet for a fastener (clips, clamps, rivets, or the like). Alternatively, the fasteners could also be integrally formed with the base plate.

According to a preferred embodiment of the invention, at least one of the one or more fixation elements comprises a fastener configured for snapping up a cushion-supporting spring of the seat. According to another preferred embodiment of the invention, at least one of the fixation elements may be configured for fastening the base plate to the foam of the seat. Fasteners of these different embodiments may also be combined on a single seat occupancy sensor unit.

Preferably, the seat occupancy sensor unit comprises a felt layer arranged on top of the membrane.

A preferred aspect of the invention concerns a car seat comprising a structural frame, a cushion that may be occupied by a seat occupant, at least one of a cushion-supporting spring structure and a seat pan, and a seat occupancy sensor unit as described herein, the seat occupancy sensor unit being arranged between the cushion and the at least one of a cushion-supporting spring structure and seat pan.

### BRIEF DESCRIPTION OF THE DRAWINGS

A preferred embodiment of the invention will now be described, by way of example, with reference to the accompanying drawings in which:

FIG. 1 is an isometric exploded view of a seat occupancy sensor unit comprising a pressure sensor and a base plate;

FIG. 2 is an illustration of the different layers of the pressure sensor of the seat occupancy sensor unit of FIG. 1;

FIG. 3 is a perspective view of the top side of the base plate of the pressure sensor of the seat occupancy sensor unit of FIG. 1;

FIG. 4 is a perspective view of the bottom side of the base plate of the pressure sensor of the seat occupancy sensor unit of FIG. 1;

FIG. 5 is a schematic circuit diagram of the seat occupancy sensor unit;

FIG. 6 is a perspective view of the fixation of a variant of the base plate of FIG. 4 to the cushion-supporting springs of a seat;

FIG. 7 corresponds to FIG. 6, wherein the straps interconnecting the cushion-supporting springs have been omitted;

FIG. 8 is a schematic longitudinal cross-sectional view of a car seat comprising a pressure-responsive B-surface seat occupancy sensor unit.

### DESCRIPTION OF PREFERRED EMBODIMENTS

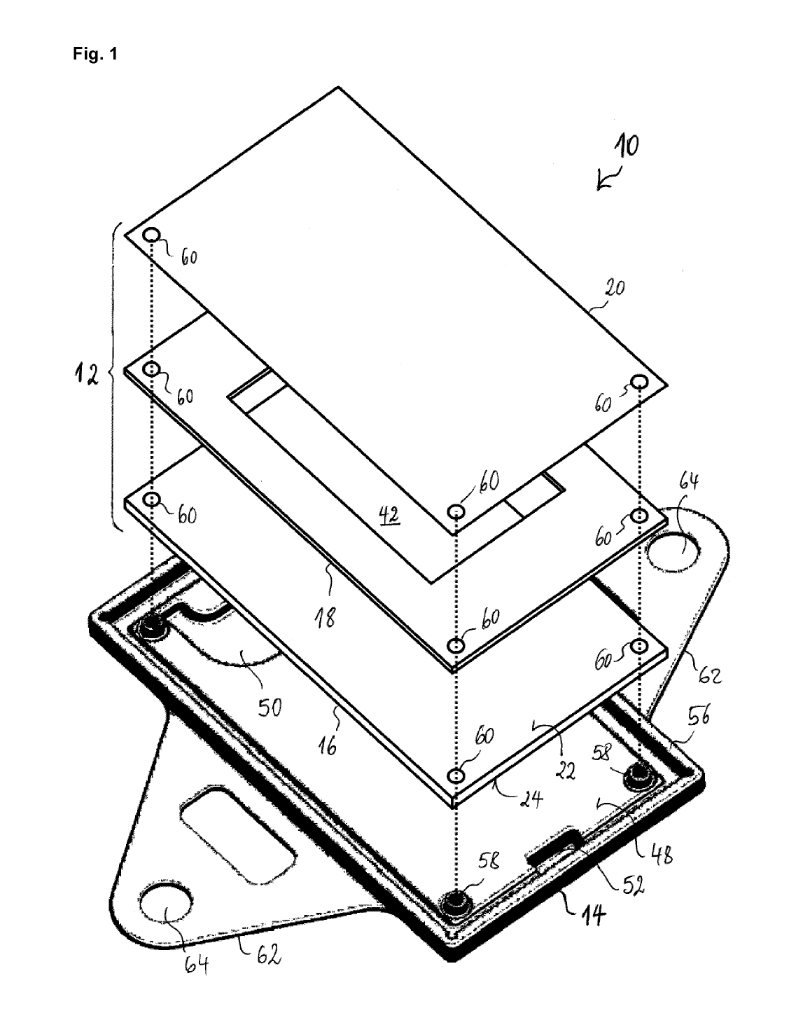

FIGS. 1 to 5 show a preferred embodiment of a seat occupancy sensor unit 10 comprising a pressure sensor 12 and a base plate 14. The pressure sensor comprises a double-layer printed circuit board 16 (e.g. an FR4 PCB but other materials be used), a spacer 18 and a membrane formed by metal foil 20. The spacer 18 is sandwiched between the PCB 16 and the metal foil 20, so as to maintain the metal foil 20 at a certain distance from the upper surface 22 of the PCB 16. The PCB 16 rests with its lower surface 24 on the base plate 14.

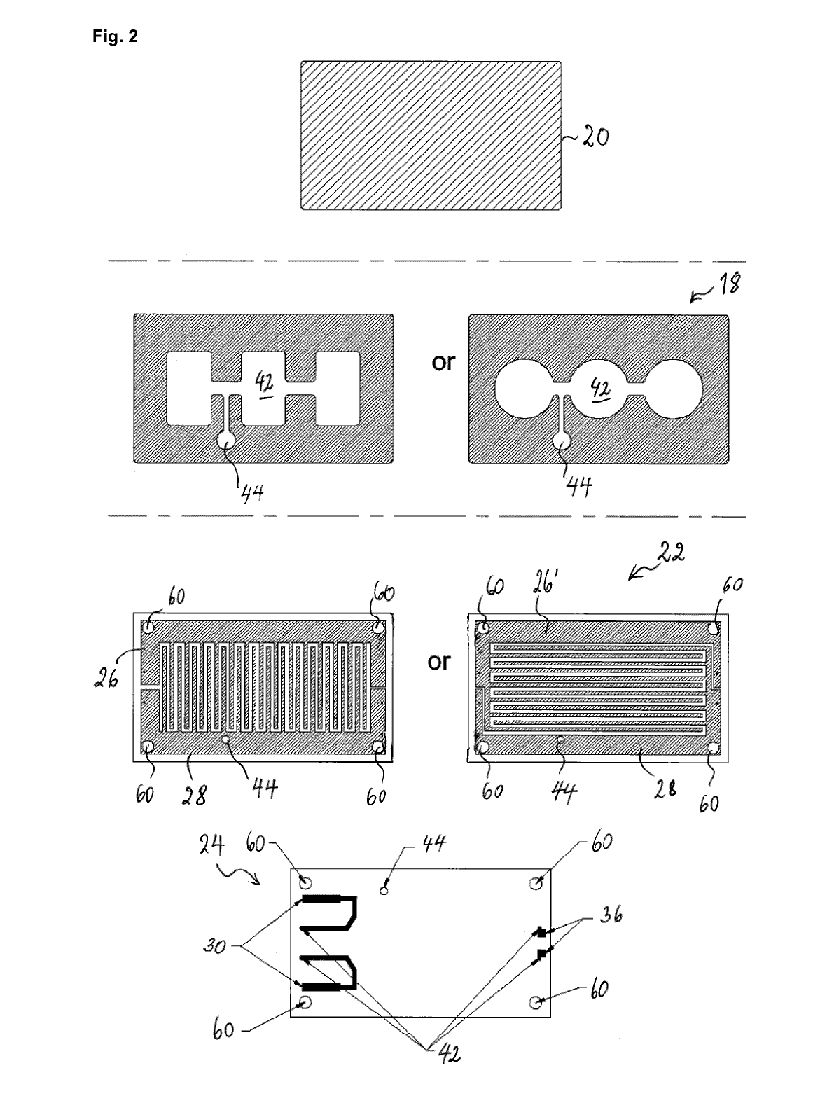

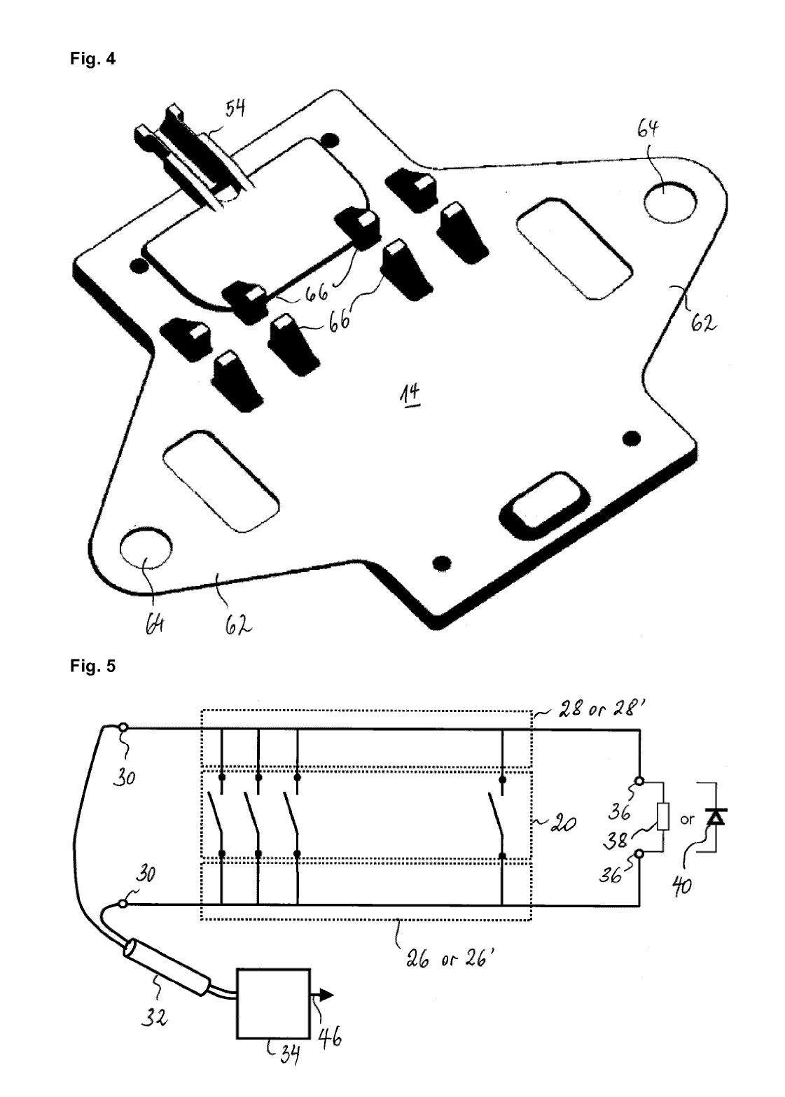

As best shown in FIG. 2, the PCB 16 comprises on its upper surface 22 two mutually interdigitated electrodes 26, 28 or 26′, 28′. In the illustrated variants, the electrode fingers have a width of 0.15 mm and are separated by a gap of 0.15 mm. The finger structure enables to correct positioning errors of the spacer. If during assembly of the seat occupancy sensing unit 10, the spacer is arranged somewhat off its theoretical position, the activation pressure of the pressure sensor does not vary significantly. Other configurations (shape design and orientation) than those shown in FIG. 2 are possible. On the bottom surface 24, the PCB comprises soldering pads 30 for connecting the electrodes 26, 28 or 26′, 28′ to a connection cable 32 (FIG. 5) that connects the electrodes to a control and evaluation circuit 34 (e.g. an ASIC). Further soldering pads 36 are provided on the bottom surface for interconnection of the electrodes 26, 28 or 26′, 28′ with an integrity check component, such as a resistor 38 or a diode 40 (FIG. 5). The integrity check component is thus directly soldered on the PCB, which makes its integration very easy. (That is not the case with a film-type pressure sensor, where the integrity check component is typically moulded in a hotmelt block that has to be integrates separately into the seat.) The electrodes are 26, 28 or 26′, 28′ electrically connected to the respective soldering pads 30, 36 by means of VIAs 42.

The control and evaluation circuit 34 attempts to drive a current across the electrodes 26, 28 or 26′, 28′. When the seat is unloaded (not occupied), the electrodes 26, 28 or 26′, 28′ are interconnected via the resistor 38 and/or the diode 40 only. When the seat is occupied, the foam of the seat cushion exerts pressure on the metal foil 20, which bends downward through the opening 42 in the spacer 18 and eventually gets into contact with the electrodes 26, 28 or 26′, 28′. As a consequence, the electrical resistance between the electrodes 26, 28 or 26′, 28′ drops significantly (i.e. well below the resistance of the resistor 38 or the diode 40) when sufficient pressure is applied on the seat cushion. The metal foil 20 thus plays the role of a pressure-activated switch, as which it is represented in FIG. 5. The control and evaluation circuit 34 outputs a signal indicative of whether the seat is occupied or not on its signal output 46.

The opening 42 in the spacer 18 may have various shapes, as illustrated in FIG. 2. Other shapes are of course possible. The specific design of the opening 42 determines where the metal foil 20 and the PCB 16 get into contact. In the illustrated designs, there are three communicating contact cells but the number of cells can again be chosen in accordance with the desire activation pressure.

In the illustrated embodiment, the spacer 18 is formed by a double-sided adhesive (e.g. a PET film coated with acrylate adhesive). The height (thickness) of the spacer 18 determines how much deflection of the metal foil 20 will be necessary for establishing a contact. Accordingly, the height of the spacer 18 and the thickness of the metal foil 20 are chosen in such a way that the desired pressure threshold (activation pressure) of the pressure sensor 12 is achieved. The metal foil 20 may e.g. be made of a 50 μm thick steel, copper or brass foil. The metal foil 20 has essentially the same dimensions as the PCB 16 (e.g. 40 mm×70 mm as in the illustrated example).

It will be appreciated that the PCB and the metal foil have small temperature coefficients (10×10⁻⁶ to 20×10⁻⁶ K⁻¹). Any residual temperature-dependent behaviour (temperature induced shift of the activation pressure) of the pressure sensor 12 is, therefore, mainly due to the triggered by the adhesive of the spacer 18. Advantageously, the spacer 18 is thus chosen with a small amount of glue. As an alternative, one could use a spacer without any glue. In that case, the PCB, the spacer and the membrane are preferably held together by mechanical fixations, such as e.g. clamps, rivets, screws or other fasteners.

The seat occupancy sensor unit 10 is configured in such a way that, when it is arranged on the B-surface of the car seat, i.e. between the foam of the seat cushion and the seat pan or the cushion-supporting springs, it has following characteristics:
when a 5th-percentile female sits on the seat, the electrical resistance between the leads of the connection cable drops from infinity (or the resistance value of the integrity check component) to a resistance less than 100 Ω, whatever the ambient temperature may be in the range from −40° C. to 85° C.
when lighter objects (like a laptop or a handbag) are arranged on seat, no resistance variation can be detected between the leads of the connection cable (the resistance remains infinity or the integrity check resistance value) over the temperature range from −40° C. to 85° C.

The opening 42 in the spacer 18 is fluidly connected to the outside by means of a ventilation hole 44, which extends through the spacer 18 and through the PCB. Thanks to the ventilation hole 44, air pressure inside and outside the pressure sensor is the same and thus has no impact on the measurement. Furthermore, the activation pressure of the pressure sensor 12 can be easily tested by connecting an underpressure tester to the outlet of the ventilation hole 44 and applying a vacuum. Those skilled will appreciate that it is not necessary to perforate the metal foil 20 to provide a ventilation hole.

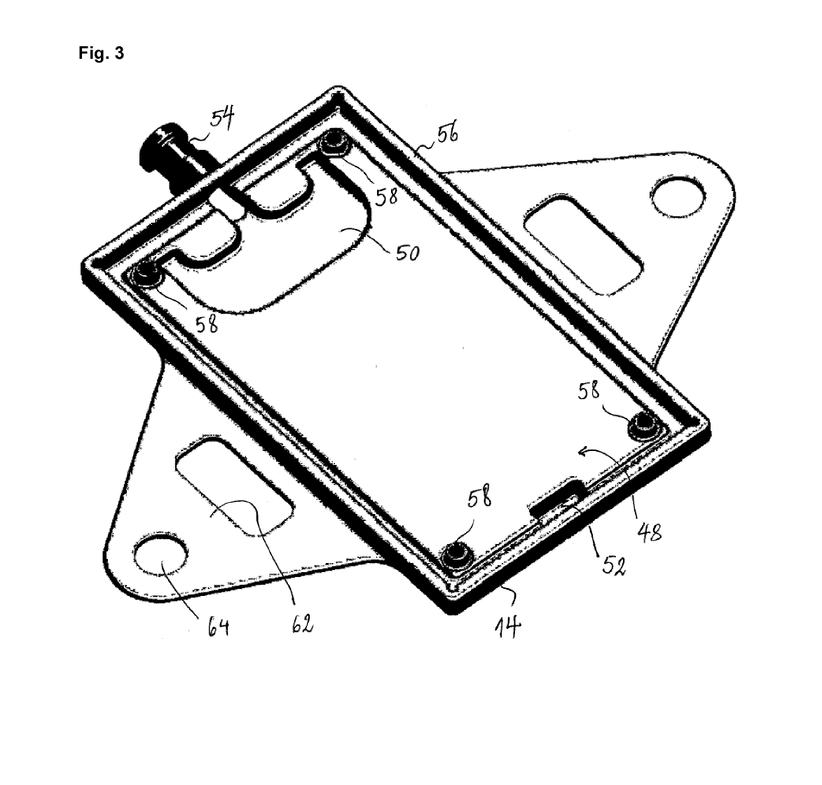

As best shown in FIG. 3, the base plate (preferably made of plastic) comprises a generally flat surface 48 on which the pressure sensor 12 is applied. The surface 48 presents recesses 50, 52 that are disposed so a to accommodate the components on the bottom surface 24 of the PCB 16, in particular the soldering pads 30, 36 and the integrity check component. An elevated border 56 is provided on the base plate 14 as a lateral protection of the pressure sensor 12. The correct position of the pressure sensor 12 is ascertained by positioning pins 58 protruding from the top surface 48 of the base plate 14 and cooperating with corresponding positioning holes 60 on the pressure sensor 12.

A cable guide 54 is integrally formed with the base plate 14 for guiding the connection cable 32 to the bottom surface 24 of the PCB 16. The cable guide is configured so as to cramp the connection cable 32, whereby any tension on the cable may be taken up by the base plate 14 and is not directly transmitted to the soldering pads 30.

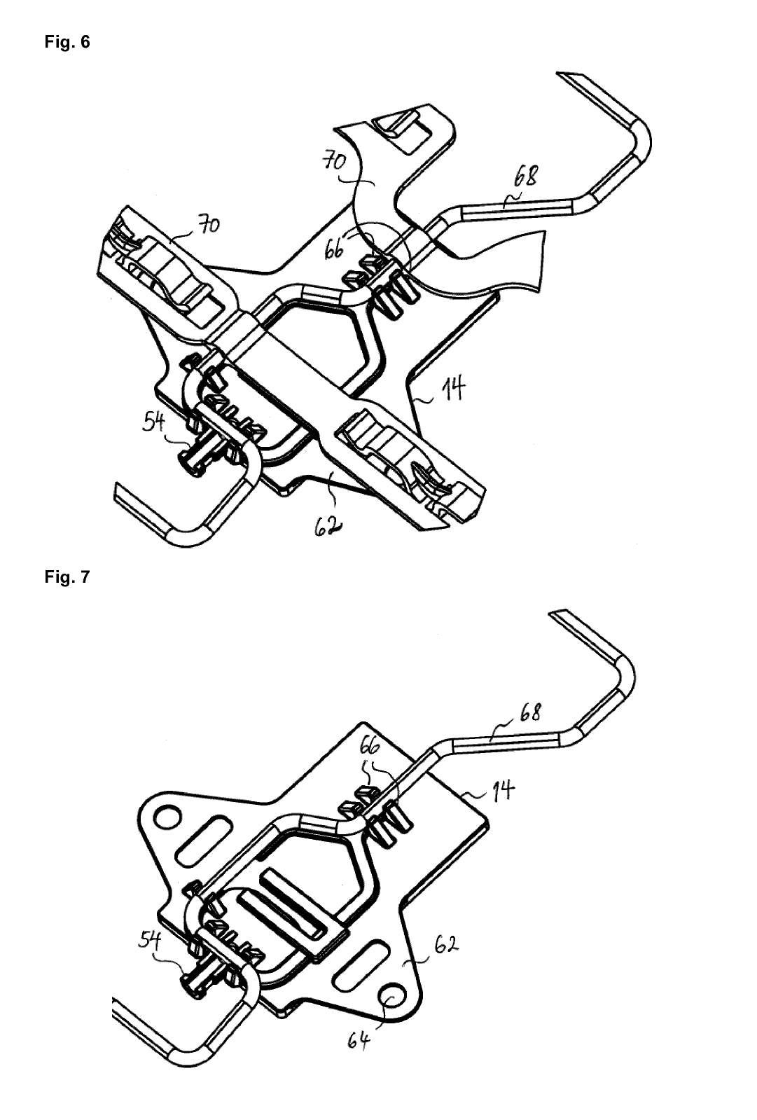

The base plate 14 further comprises wing members 62, which are integrally formed with the main body of the base plate 14 and which comprise a first group of fixation elements for attaching the seat occupancy sensor unit 10 to the vehicle seat. The first group of fixation elements comprises eyelets 64 at the tips of the wing members 62. Thanks to these eyelets, the seat occupancy sensor unit 10 may easily be connected to the seat pan, the cushion-supporting springs, the straps 70 (see FIG. 6) interconnecting the cushion-supporting springs or the foam cushion using appropriate fasteners (not shown). The wing members 62 are thinner and, therefore, less rigid than the main body of the base plate 14. The wing member may thus bend when the seat is loaded.

A second group of fixation elements 66 are arranged on the bottom side of the base plate 14, as shown in FIGS. 5, 6 and 7. The wedge-shaped fixation elements 66 protrude from the bottom surface of the base plate 14. They are arranged pairwise opposite each other so as to form an interstice just broad enough to receive therein a cushion-supporting spring 68 (see FIGS. 6 and 7) of the seat. The fixation elements 66 thus fix the seat occupancy sensor unit 10 on that spring 68.

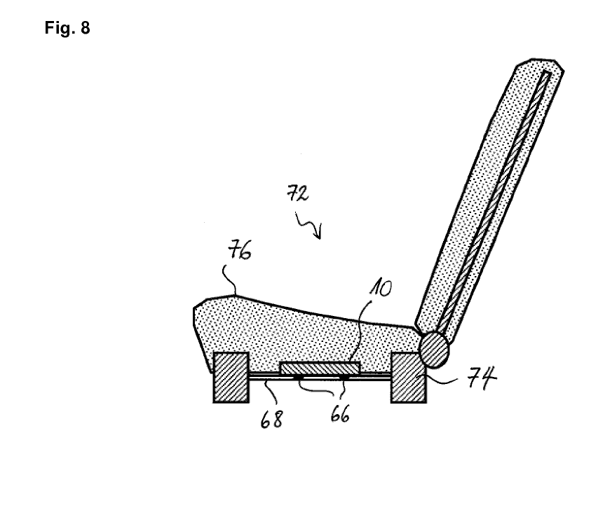

FIG. 8 is a schematic illustration of a car seat 72 comprising a seat occupancy sensor unit 10. The car seat 72 comprises a structural frame 74, which supports the upholstery elements (cushions and trim). The seating cushion 76 of the car seat 72 rests on cushion-supporting springs 68 taught between opposite components of the structural frame 74. The seat occupancy sensor unit 10 is sandwiched between the springs 68 and the lower side (B-surface) of the seating cushion 76. The seat occupancy sensor unit 10 is fixed to one or more of the springs 68 by the fixation elements 66 at the bottom side of the base plate of the seat occupancy sensor unit 10.

Those skilled will appreciate that the seat occupancy sensor unit 10 is of modular construction. The base plate may be configured such that is suitable for a large group of vehicle seats. Any fixation elements not needed for fixation on a particular type of seat could be removed before, during or even after the integration of the unit into the seat. If modification of the activation pressure is necessary, that can be achieved by design of the spacer opening 42. The other components of the unit need not be modified. As will further be appreciated, one may choose standard materials for the seat occupancy sensor unit; these can thus be ordered independently from any specific customer application.

While a specific embodiment has been described in detail, those with ordinary skill in the art will appreciate that various modifications and alternatives to those details could be developed in light of the overall teachings of the disclosure. Accordingly, the particular arrangements disclosed are meant to be illustrative only and not limiting as to the scope of the invention, which is to be given the full breadth of the appended claims and any and all equivalents thereof.

### Legend

10 Seat occupancy sensor unit
12 Pressure sensor
14 Base plate
16 Printed circuit board
18 Spacer
20 Metal foil
22 Upper surface of the PCB
24 Lower surface of the PCB
26, 26′ Electrode
28, 28′ Electrode
30 Soldering pads
32 Connection cable
34 Control and evaluation circuit
36 Soldering pads
38 Resistor
40 Diode
42 Opening
44 Ventilation hole
46 Signal output
48 Top surface of the base plate
50 Recess
52 Recess
54 Cable guide
56 Border
58 Positioning pins
60 Positioning holes
62 Wing member
64 Eyelet
66 Wedge-shaped fixation elements
68 Cushion-supporting spring
70 Straps interconnecting cushion-supporting springs
72 Car seat
74 Structural frame
76 Seating cushion

1. A pressure-responsive B-surface seat occupancy sensor unit for detecting an occupancy state of a seat, in particular a vehicle seat, comprising
a pressure sensor that includes
a printed circuit board having a first surface with at least two electrodes and a second surface;
and a membrane element arranged in facing relationship with and spaced from said at least two electrodes so as to be able to deflect under pressure and establish an electrical contact between said at least two electrodes;
and a base plate, which said printed circuit board is arranged on with its second surface, said base plate including one or more fixation elements, by means of which said base plate is fixable to a structural frame, a cushion and/or a cushion-supporting spring of said seat.

2. The seat occupancy sensor unit as claimed in claim 1, wherein said pressure sensor comprises one or more spacer elements arranged between said printed circuit board and said membrane element and attaching said printed circuit board and said membrane element to one another.

3. The seat occupancy sensor unit as claimed in claim 2, wherein said one or more spacer elements are substantially incompressible.

4. The seat occupancy sensor unit as claimed in claim 1, wherein said membrane element comprises a metal foil.

5. The seat occupancy sensor unit as claimed in claim 1, wherein said membrane comprises a bendable carrier plate or film having applied thereon an electrically conductive layer.

6. The seat occupancy sensor unit as claimed in claim 1, wherein said at least two electrodes are arranged mutually interdigitated.

7. The seat occupancy sensor unit as claimed in claim 1, wherein said printed circuit board comprises, on said second surface, electrical connection elements electrically contacted with one or more of said at least two electrodes by VIAs.

8. The seat occupancy sensor unit as claimed in claim 7, wherein said at least two electrodes are interconnected by at least one integrity check component arranged on said second surface.

9. The seat occupancy sensor unit as claimed in claim 7, wherein said base plate comprises one or more clearances for accommodating electrical components on said second surface of the printed circuit board.

10. The seat occupancy sensor unit as claimed in claim 1, wherein said base plate comprises positioning elements holding said printed circuit board in its correct position.

11. The seat occupancy sensor unit as claimed in claim 1, wherein said base plate comprises a cable guide for guiding a connection cable to said printed circuit board, and, optionally, cramping said connection cable.

12. The seat occupancy sensor unit as claimed in claim 1, wherein at least one of said one or more fixation elements comprises an eyelet for a fastener.

13. The seat occupancy sensor unit as claimed in claim 1, wherein at least one of said one or more fixation elements comprises a fastener configured for snapping up a cushion-supporting spring of said seat.

14. The seat occupancy sensor unit as claimed in claim 1, comprising a felt layer arranged on top of said membrane.

15. Car seat comprising
a structural frame,
a cushion that may be occupied by a seat occupant,
at least one of a cushion-supporting spring structure and a seat pan, and
a seat occupancy sensor unit as claimed in claim 1, said occupancy sensor unit being arranged between said cushion and said at least one of a cushion-supporting spring structure and seat pan.

16. The seat occupancy sensor unit as claimed in claim 8, wherein said base plate comprises one or more clearances for accommodating electrical components on said second surface of the printed circuit board.
